(19) United States
(12) Patent Application Publication
(10) Pub. No.: US 2011/0020558 A1
(43) Pub. Date: Jan. 27, 2011

(54) DRY LUBRICATION METHOD EMPLOYING OIL-BASED LUBRICANTS

(75) Inventors: Holger Theyssen, Freinsheim (DE); Stefan Grober, Frankenthal (DE); Harry Kany, Hettenleidelheim (DE); Markus Wloka, Essen (DE)

Correspondence Address: Diversey, Inc., 8310 16TH STREET, M/S 509, PO BOX 902, STURTEVANT, WI, 53177-0902, US

(73) Assignee: DIVERSEY, INC., Sturtevant, WI (US)

(21) Appl. No.: 12/934,518

(22) PCT Filed: Mar. 25, 2009
(86) PCT No.: PCT/US09/38227

§ 371 Date: Sep. 24, 2010

(30) Foreign Application Priority Data
Mar. 25, 2008 (EP) 08005456.2

(51) Int. Cl. B05D 1/36

(52) U.S. Cl. 427/402

(57) ABSTRACT

The present invention relates to a method of lubricating a conveyor belt wherein a lubricant concentrate containing at least one oil is employed in a dry lubrication process. Afterwards, a liquid composition having a pH-value ≧5 is applied to the surface of the conveyor belt on which the lubricant concentrate has been applied earlier.

The present invention relates to a method of lubricating a conveyor belt wherein a lubricant concentrate containing at least one oil is employed in a dry lubrication process. Afterwards, a liquid composition having a pH-value ≧5 is applied to the surface of the conveyor belt on which the lubricant concentrate has been applied earlier.

Known conveyor belt lubricants are employed in applications in which good gliding contact between solid surfaces, for instance glass and metal, or plastic and metal must be ensured. These applications include bottle filling and conveying plants, where the lubricants are applied to the conveyor belts to ensure the trouble-free conveyance of bottles on the belt. In many known systems, a soap such as potash-based (potassium based) soft soap is used as the lubricant. The soaps are usually produced from an acidic educt such as a fatty acid and a basic educt such as alkanol amines or alkaline hydroxides. Such soap-based lubricants are usually in the alkaline pH-range of about 8 to 12 and are disclosed, for example, in U.S. Pat. No. 5,391,308, U.S. Pat. No. 4,274,973, or U.S. Pat. No. 3,336,225.

As a substitute for the soap-based lubricants, a variety of synthetic conveyor belt lubricants including certain amine compounds are being used. These synthetic lubricants have been described in, for example, EP-A 1690920, which discloses a lubricant concentrate containing a phosphate tri-ester. Said lubricant concentrate contains as further components an amine and an acid which may be an inorganic acid such as hydrochloric acid, nitric acid or phosphoric acid or an organic acid such as formic acid, acetic acid or oleic acid. Due to the presence of the amine, the pH-value of the respective lubricant is usually in a range of 6 to 12.

These conveyor belt lubricants are generally supplied as concentrates. Use concentrations (or use solutions) of such concentrates are usually prepared by applying typical dilution rates of 0.2-1.0% by weight of the respective concentrate in water depending on the friction requirement and the water type. Such aqueous belt lubricants (aqueous use solution) having a use concentrate of the active lubricating ingredients of significantly less than 0.1% by weight have been satisfactorily applied for many years. Such aqueous use solutions are also known as “wet lubricants”.

WO 01/23504 relates to such a wet lubrication process, wherein an antimicrobial lubricant composition is used to treat or lubricate containers and/or conveyor systems for containers. The employed lubricant composition comprises a lubricating agent and an antimicrobially effective amount of a quaternary phosphonium compound. The lubricant agent comprises a non-neutralized fatty acid, which may be oleic acid.

US-A 2004/0 102 334 relates to a lubricant concentrate comprising a fatty acid and a neutralisation agent such as alkaline metal hydroxide, urea or alkyl amines. The lubricant additionally contains a pH-buffer for providing a pH-value between 5 and 9.

U.S. Pat. No. 6,288,012 relates to a non-aqueous lubricant for lubrication of containers and conveyor systems, whereby the substantially non-aqueous lubricant can include natural lubricants, petroleum lubricants, synthetic oils, greases and solid lubricants.

U.S. Pat. No. 4,420,578 relates to a composition for coating returnable glass bottles comprising among others 0-50 wt.-% of a fatty carboxylic acid, for example mixtures of long-chain carboxylic acids. However, said composition is employed for coating glass bottles instead of lubricating a conveyor belt.

US-A 2005/0 288 191 relates to a conveyor lubricant composition comprising at least one lubricant and at least one protectant for PET bottles such as alkyl ether carboxylic acid or salts thereof. The lubricant employed may be any lubricant known to a skilled person including fatty acids (such as oleic acid) or alkanol amines.

EP-A 1 840 196 relates to a lubricant composition for conveyor systems comprising phosphoric acid esters, ether carboxylates, water and C₆-C₂₂ fatty acid, such as oleic acids, and/or C₆-C₂₂ fatty alcohols.

U.S. Pat. No. 5,723,418 relates to a lubricant concentrate composition containing an effective lubricating amount of amine, a corrosion inhibitor and a surfactant. A fatty acid may be added to said composition as a neutralizing agent for obtaining a pH-value ranging from about 5-10.

U.S. Pat. No. 5,399,274 relates to a lubricant composition for use in metal-working processes comprising a fatty acid, an amino alcohol and a phosphate ester. The fatty acids employed are neutralized with an amino alcohol and complexed with an organic phosphate ester for obtaining a pH of the lubricant of at least about 8. The lubricant is useful in sizing, coining and machining of powdered metal parts and/or conventional ferrous and non-ferrous metal parts.

US-A 2004/0 241 309 relates to an improved food-grade lubricant useful, for example, as hydraulic oil or compressor oil. The lubricant comprises at least one vegetable oil, at least one polyalphaolefin and at least one antioxidant.

U.S. Pat. No. 4,839,067 relates to a process for lubrication and cleaning of bottle conveyor belts without the formation of tenacious deposits and objectionable odours as when using potash-based soaps as wet lubricant. The process comprises a first step of applying a lubricant comprising a base of neutralized primary fatty amines on the conveyor belt. The lubricant can be neutralized to a pH-value of 6-8 with acetic acid. In a second step, the conveyor belt is cleaned with at least one cleaning agent selected from cationic cleaning agents (for example, quaternary ammonium compounds such as alkyl dimethyl benzyl ammonium) and an organic acid. It is indicated that said cleaning step can be carried out once in a while, for example, daily or weekly. However, the removal of dirt or deposits from a conveyor belt is usually already performed by the wet lubrication process itself (such as the first step of the method described in U.S. Pat. No. 4,839,067), since most of the employed lubricant (use solution) drops off from the surface of the respective conveyor belt. The off-dropping (off-flowing) liquid usually takes away most of the dirt or deposits from the surface of the conveyor belt.

However, none of the above-described (mostly aqueous) lubricants are employed in a dry lubrication process. Most of them are employed as use solutions and therefore as wet lubricants, some of them are even used in different applications such as hydraulic oils. Only some of those lubricants are based on oils.

On the other hand, the application of these aqueous lubricants (wet lubricants) has also resulted in high water usage rates and relatively high effluent costs for the user. Furthermore, when used as conventionally intended these aqueous lubricants flow off the conveyor track surface treated therewith, resulting in a waste of chemical and water, and causing a slippery floor surface which may constitute a hazard to operators working in the immediate environment and collecting on floors and other surfaces which then requires cleaning.

In order to overcome the before-mentioned disadvantages of employing wet lubricants, WO 01/07544 discloses the use of a liquid composition for lubricating conveyor belts as a so-called “dry lubricant”. The liquid composition is suitable for producing a dry lubricant film which remains on the surface of the respective conveyor belt onto which it is applied (as a liquid) and which consequently does not flow off from said surface. The liquid is usually an aqueous phase (up to 95% by weight of water) and further comprises a silicone oil or other oils selected from vegetable oils, mineral oils and mixtures thereof. Vegetable oils may be soy oil, palm oil, olive oil or sunflower oil. The liquid composition is suitable for continuous application to the conveyor belt surface, with or without further dilution with water, to remove incidental spillages of extraneous material from the conveyor belt surface without loss of the required lubricity. According to the working examples of WO 01/07577, the conveyor belts are sprayed with water after a certain time of operation under dry lubrication conditions.

The international application PCT/US2007/087143 relates to a method of lubricating a conveyor belt wherein the lubricant concentrate is employed as a dry lubricant in a dry lubrication process. The lubricant concentrate contains at least 0.1 wt.-% of at least one free fatty acid and at least one corrosion inhibitor.

US-A 2005/0 059 564 relates to a composition and method of lubricating conveyor tracks or belts wherein the lubricant composition contains at least about 25 wt.-% of fatty acid. The lubrication process may optionally be carried out as a dry lubrication. In one embodiment, the fatty acid may be present in its free form. A similar disclosure to US-A 2005/0 059 564 can be found in U.S. Pat. No. 6,855,676.

U.S. Pat. No. 6,427,826, U.S. Pat. No. 6,673,753 and EP-A 1 308 393 relate to further lubrication methods, which may optionally be carried out as a dry lubrication. Various types of lubricants may be employed such as lubricants based on water-miscible silicon material or mineral oils. The lubricants may additionally contain fatty acids such as oleic acid. In EP 1 308 393, it is further indicated that a container or conveyor belt may optionally be cleaned from a silicon-based lubricant by treatment with water or using common or modified detergents including, for example, one or more surfactants, an alkalinity source or water-conditioning agents.

However, nowhere within said documents describing a dry lubrication process as an optional form of lubricating a conveyor belt, a method is disclosed wherein a dry lubrication with an oil is carried out followed by the application of a liquid composition containing a base and a fatty acid and having a pH-value of ≧5.

One major advantage of the method of dry lubrication versus wet lubrication is the drastic reduction in the volumina of the respective liquid, which is employed for lubrication. In an ordinary dry lubrication of a conveyor belt, approximately 1.5 to 20 ml/h of the respective lubricant are applied on the conveyor belt (as dry lubricant), whereas in case of wet lubrication, approximately 10-30 l/h of an aqueous solution have to be applied on the same conveyor belt. The voluminas of the respective liquid lubricants to be employed on the conveyor belt usually differ by the factor of 1000 to 10000 (wet lubrication versus dry lubrication).

However, the method of dry lubrication as described, for example, in WO 01/07544 is also associated with some disadvantages. Especially due to the employment of dry lubricants containing vegetable oils or, in particular, mineral oils, a so-called blackening is observed on the bottom surface of the containers to be transported on the conveyor belt. This blackening is often caused by dirt usually attached to the container surface, especially in case of the transportation/re-filling of used containers or by wear of, for example, glass or metal originating from the objects to be transported on the conveyor belt. A further source of dirt on the conveyor belt are fractions of liquids such as beer or sugar-containing beverages, which have not been filled into the container during the respective (re-)filling process but have flown down on the outer surface of the respective container onto the conveyor belt. The blackening problem usually occurs only in the case of a dry lubrication process, but not during a wet lubrication process, since most of the dirt is carried away from the surface of the conveyor belt by the lubricant use solution flowing off.

Since it is difficult to remove said mixture of dirt and vegetable oil or especially mineral oil from the conveyor belt to avoid blackening, the whole conveyor belt system has to be stopped from time to time to perform an additional cleaning step. This cleaning is usually performed by employing strong alkaline detergent compositions containing surfactants because the oil-dirt-mixtures, especially when employing mineral oils, can only be insufficiently removed by ordinary aqueous detergent compositions. If the used up lubricant film is not completely removed from the conveyor belt, the blackening problem is not solved. In addition, the new lubricant film is formed incompletely causing problems in respect of the objects to be transported. After the cleaning, further time has to be spent to sufficiently (re-)apply the lubricant on the respective conveyor belt (so-called starting phase) until the whole system can be operated without any problems in respect of the transportation of the containers.

Therefore, the object of the present invention is to provide a new method of dry lubrication for a conveyor belt.

The object is achieved by a method of lubricating a conveyor belt, comprising the steps as follows:
a) a lubricant concentrate containing at least one oil is employed in a dry lubrication process,
b) afterwards, a liquid composition is applied to the surface of the conveyor belt, wherein
the pH-value of the liquid composition is in a range of ≧5.
the liquid composition contains as component a) at least one base and
the liquid composition contains as component b) at least one fatty acid.

A major advantage of the method according to the present invention is that excellent lubricity is provided on the conveyor belts (due to low friction) during the dry lubrication process (step a). The dry lubrication process according to step a) of the present invention provides improved lubricity compared to dry lubrication processes employing different types of lubricant concentrates or compared to the corresponding wet lubrication processes. In addition, the power consumption of the engines of the conveyor belts can be reduced by 10 to 20% at a dry lubrication process compared to the corresponding wet lubrication process.

Due to step b) according to the method of the present invention, the dirt attached to the surface of the conveyor belt (causing the blackening on the bottom surface of the containers to be transported) can be easily removed. Therefore, step b) has to be considered as a cleaning (washing) step on the one hand. This washing is very effective, since the dry lubricant (oil) and the components of the liquid composition of step b) usually build up a dispersion, which can be easily washed away. Whereas the base itself has no or only very limited lubrication properties, the soap contained in the liquid composition due to the presence of a base and a fatty acid has excellent lubrication properties. The soap can be considered either as a chemical reaction product or an adduct of the base and the fatty acid. By consequence, step b) can also be considered as combined washing and lubrication step.

Since the liquid composition employed in step b) does not only contain a base as a component, but also at least one fatty acid as an additional component, there is always a supply of fresh soap from the liquid composition to the conveyor belt surface as long as step b) is carried out. This is a big advantage, since the soap does not only effect a fast removal of the dirt and the incomplete or damaged dry lubrication film from the conveyor belt, but it additionally provides continued lubrication on the conveyor belt. The removal of the dirt from the conveyor belt surface occurs faster if the liquid composition contains a molar excess of base versus fatty acid. By consequence, excellent lubricity is maintained during the subsequent cleaning (washing) step b). This means that the operation of the conveyor belt does not have to be interrupted at all when effectively removing dirt from the conveyor belt to avoid the blackening of the containers to be transported. Therefore, such a conveyor belt can be operated in a 24/7-operation mode (7 days a week for 24 hours each).

Since the cleaning due to step b) is very effective, step b) does not have to be carried out for a very long time. It is very easy to switch back to the dry lubrication according to step a) As indicted above, the dry lubrication process is also favourable in respect of the lubricity.

Another advantage of the method according to the present invention is that in those embodiments, where in step a) a lubricant concentrate is employed containing an oil and a compound which is useful as an emulsifier and/or a corrosion inhibitor, the corrosion of the conveyor belt, further conveyor equipment and/or the object to be transported can be reduced. This is for example the case when objects made of tin plate are transported on a conveyor belt, even if the conveyor belt is made from stainless steel. The combination of an oil and such a compound which is useful as an emulsifier and/or corrosion inhibitor has the additional effect of a reduced blackening on the objects to be transported.

The method according to the present invention provides excellent lubricity independent of the kind/quality of the object to be transported or the material of the conveyor belt. The objects to be transported may be partially or completely made of glass, metal, carton, or plastics and the conveyor belt may be partially or completely made of steel or plastic. The method according to the present invention provides excellent lubricity for the transportation of, for example, glass bottles on stainless steel conveyor belts. The transportation of objects to be filled and in particular to be refilled on conveyor belts, where neither the object to be transported nor the conveyor belt itself is partially or completely made of plastics, has been quite complicated so far. The method according to the present invention provides improved lubricity for the transportation of used objects made of glass on stainless steel conveyor belts or of objects made of plastic on a plastic conveyor belt.

Chelating agents such as EDTA are used to prevent lime soap formation on the conveyor belt. The formation of lime soap on a conveyor belt normally occurs by employing neutral to alkaline lubrication conditions. The lime soap formation has the negative side effect that it drastically reduces or even stops the lubrication on the respective conveyor belt. The employment of chelating agents such as EDTA has the negative side effect that they are not readily biodegradable. Since in some embodiments of the present invention, the lubricant concentrates employed in step a) of the present invention are in the acidic range of the pH-spectrum due to the presence of a fatty acid and/or a further acid, no formation of lime soap occurs. In addition, the rather low pH-range of the lubricant concentrate provokes a biostatic effect and no growing of bacteria or food and/or beverage parasites occurs. A further stabilization of the respective lubricant concentrate is obtained when employing another acid besides the fatty acid, such as acetic acid.

The term “dry lubricant” in connection with the present invention means that the employed lubricant is applied on the respective conveyor belt (in step a) in a way that the respective lubricant remains on the surface of said conveyor belt either completely or at least substantially. Remaining substantially means that not more than 10% by volume of the employed lubricant are flown off (dropped off) the respective conveyor belt. For the sake of clarity, it is indicated that the dry lubricant itself is usually employed as a liquid, for example, as an emulsion or a solution. The process (method) connected with the application of said dry lubricant is defined as “dry lubrication (process)”. Preferably, the lubricant concentrate is added within a dry-lubrication process according to the present invention at a ratio of 1.5 to 20 ml/h, in particular about 5 ml/hour, on the respective conveyor belt (per conveyor belt track depending on ordinary size of 5-20 m, preferably about 12 m).

The term “wet lubricant” in connection with the present invention means that the respective lubricant is applied onto the surface of a conveyor belt in a way that a significant amount of the lubricant employed or the liquid containing the lubricant flows off from the surface of the respective conveyor belt. The process (method) connected with the application of said wet lubricant is defined as “wet lubrication (process)”. Preferably, at least 30% of volume of the employed amount of liquid flows off, more preferably at least 50% by volume, in particular at least 90% by volume. Preferably, the lubricant is added within a wet lubrication process at a ratio of 1.5 to 20 l/hour on the respective conveyor belt (per conveyor belt track/ordinary size of 5-20 m, preferably about 12 m).

The term “lubricant concentrate” in connection with the present invention means that the respective lubricant contains one oil or a mixture of two or more oils, preferably in an amount of at least 0.1 wt.-%. The lubricant concentrate may contain further components including at least one emulsifier, water or organic solvents, resulting in a total of 100 wt.-% (sum of oil and further components).

The term “use solution (of a lubricant)” in connection with the present invention means that the amount of one oil or a mixture of two or more oils contained within the respective lubricant is preferably below 0.1 wt.-%, more preferably below 0.01 wt.-%. Usually a use solution of a lubricant is obtained by diluting the respective lubricant concentrate with a solvent, preferably with water, by a factor of 1000 to 10000.

It has to be indicated that in the present invention chemical compounds are mentioned by their chemical structure/name in the respective pure form (before mixing them with other compounds) unless indicated otherwise. Especially when they are employed in a mixture their chemical structure may be altered due to the influence of, for example, the pH-value of the respective mixture. For example, a fatty acid may completely or partially be present in its free (usually protonated) form. This is usually the case in the acidic pH-range, for example, at a pH-value of ≦4. However, a fatty acid may also be completely or partially present in its unprotonated form. This is usually the case in the neutral or alkaline pH-range, where the fatty acid is completely or partially transferred into a corresponding salt or a chemical reaction may take place.

Subsequently, the method of lubricating a conveyor belt according to the present invention is explained in detail.

Step a):

The lubricant concentrate employed as dry lubricant (in a dry lubrication process) contains as a first component at least one oil. The oil may be any oil known to a person skilled in the art. Examples for suitable oils are mineral oils, synthetic oils, vegetable and animal (fatty) oils or essential oils. Mineral oils comprise petroleum oils and hydrocarbon oils such as white oils, which are commercially available under the trade name White Oil 40C (Texaco Nederland BV), Technical White Oil 40C (Chevron Nederland) or White Oil TEC 40 CPB (Merkur Vaseline). Vegetable oils are usually on the basis of triglycerides of saturated or (partially) unsaturated fatty acids. Oils are usually water-insoluble or substantially water-insoluble. However, oils are usually water-miscible or at least partially water-miscible. Preferred oils are able to form an emulsion with water. More preferably, the oil is a synthetic oil or a vegetable oil, most preferably a vegetable oil.

Synthetic oils are preferably silicon material or silicon-based oils (“silicon oils”), fluorinated oils and fluorinated greases available, for example, under the trademarks “Krytox” (Du Pont Chemicals) or “Bacchus”. Some of those synthetic oils are disclosed, for example, in EP-A 1 308 393. The synthetic oils are preferably water-miscible. The silicon oil is preferably selected from alkyl and aryl silicons, functionalized silicons such as chlorosilanes, amino-, metoxy-, epoxy- and vinyl-substituted siloxanes and silanoles and, more preferably, po!ydimethyl silsxanes. Most preferably, the synthetic oil is a silicon oil being able to form an emulsion with water.

Vegetable oils are usually obtained from seeds, plants or fruits. The term vegetable oil also comprises Godified vegetable oils which are modified either chemically or genetically. Examples of vegetable oils are disclosed in US-A 2004/0241309. Preferred vegetable oils are selected from soybean nil, rapeseed nil, olive nil, sunflower oil, coconut oil, lesquerella oil, canola oil, peanut oil, corn oil, cottonseed oil, palm oil, coconut oil, safflower oil, meadowfoam oil, or castor oil. More preferred vegetable oils are selected from rapeseed oil, soy oil, palm oil, olive oil or sunflower oil.

In one embodiment of the present invention, the oil is employed in step a) in its pure or nearly pure form. This means that in this embodiment the lubricant concentrate contains at least 95% wt.-%, preferably at least 97 wt.-%, more preferably at least 99 wt.-% and most preferably (about) 100 wt.-% of one oil or a mixture of two or more oils.

In another embodiment, the lubricant concentrate contains at least one oil or a mixture of two or more oils in an amount of at least 0.1 wt-%, preferably in an amount of 0.1 to 25 wt-%, more preferably in an amount of 0.5 to 15 wt.-% and more preferably in an amount of 0.5 to 5 wt.-%.

The lubricant concentrate may contain as a further component water. Preferably, the lubricant concentrate forms a stable emulsion of at least one oil and water. The oil and water may be miscible at any ratio. If water is present, the lubricant concentrate preferably contains at least one oil in an amount of 0.1 to 25 wt.-%.

The lubricant concentrate employed in the dry lubrication process according to step a) of the present invention may have a variable pH-value depending on the further components of the lubricant concentrate. In one embodiment of the present invention, the pH-value of the lubricant concentrate is in the range of 4 to 9, more preferably 6 to 8, most preferably (about) 7.

In one embodiment of the present invention a lubricant concentrate is employed containing 0.1 to 25 wt-% of at least one oil and 5 to 95 wt.-% of water, preferably deionised water, and optionally at least 0.1 wt.-% of an emulsifier.

The lubricant concentrate may contain as a further component at least one emulsifier. Preferred emulsifiers are phosphoric acid esters (phosphate esters), which may contain fragments derived from ethylene oxide (EO) such as oleyl-3EO-phosphate esters.

In general the phosphate ester has the formula OP(OX)₃ where X is independently H or R and R may represent an aryl or alkyl group. Preferably, the phosphate ester is at least one compound having the formulae (I) or (11)

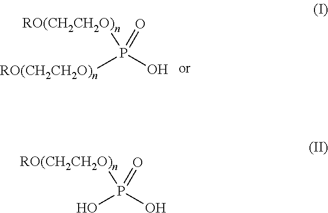

where R is an alkyl or alkylaryl group; n can (independently from another) equal from 1 to 10. Within formulae (I) or (II), R may have the same or a different meaning, if R is present more than once. Preferably, the phosphate esters do not contain my ions such as Na or K. Alkyl may be for example C₁-C₂₀-alkyl, aryl may be phenyl. In one embodiment of the present invention, a mixture of at least one compound of formula (I/diester) and at least one compound of formula (II/monoester) is employed. The ratio of diester to monoester within said mixture is from 1:4 to 4:1 [wt.-%/wt.-%], preferably about 1:1 [wt.-%/wt.-%]. In a preferred embodiment of the present invention, the phosphate ester is at least one diester according to formula (I). The diester may contain up to 10 wt.-% of the respective monoester (as a by-product).

Preferred examples of phosphate esters according to formulae (I) or (II) are (C₁₆-C₁₈)-alkyl-O-5EO-phosphate ester (mixture of mono- and diestester), (cetyl-oleyl)-O-4EO phosphate ester (mixture of monoester and diester), (C₁₂-C₁₄)-alkyl-O-4EO-phosphate ester (mixture of monoester and diester), (C₁₃-C₁₅)-alkyl-O-3E)-phosphate ester, (C₁₃-C₁₅)-alkyl-O-7EO-phosphate ester, oleyl-O-4EO-phosphate ester (mixture of monoester and diester), lauryl-O-4EO-phosphate ester and C₁₇-alkyl-O-6EO-phosphate ester (mixture of mono- and diester, preferably in a ratio of 5.5:4.5). Within said phosphate esters, a term such as “(C₁₆-C₁₈)” means that the respective alkyl residue may vary in its chain length from C₁₆ to C₁₈ or a mixture of said alkyl residues of the respective chain length are employed. The same applies to terms such as “(cetyl-oleyl)”. Said preferred phosphate esters are commercially available under the tradenames Phospholan PE 65 (Akzo Nobel), Maphos 54P (BASF), Maphos 74P (BASF), Maphos 43T (BASF), Maphos 47T (BASF), Lubrhophos LB-400 (Rhodia), Lubrhophos RD-510 (Rhodia) and Lakeland PAE 176 (Lakeland). More preferably, the phosphate esters according to formula (I) or (II) contain a (C₁₂-C₁₈)-alkyl fragment and 3 to 6 EO-fragments.

A further class of preferred emulsifiers are alkoxylated carboxylic acids, which are also known as alkylethercarboxylic acids and are saturated or unsaturated carboxylic acids containing one or more ether groups or mixtures thereof. Alkoxylated is preferably ethoxylated and means that the respective ethoxylated compound contains one or more fragments derived from ethylene oxide (EO-fragment). 3EO means that the respective compound contains 3 fragments derived from ethylene oxide. This definition also applies to the below or above mentioned compounds such as alkoxylated fatty alcohols, alkoxylated esters or alkoxylated phosphate esters.

Preferred ethoxylated carboxylic acids contain a C₄-C₁₈-alkyl fragment and 1 to 6, preferably 3 to 6, EO-fragments. C₄C₁₋₈-alkyl means that the respective fragment contains from 4 up to 18 carbon atoms, which form an alkyl residue or a mixture of the at least two alkyl residues within the indicated range is employed. Usually, ethoxylated carboxylic acids are employed as mixtures of two more acids, such as (C₁₆-C₁₈)-alkylether carboxylic acid. Preferred examples of ethoxylated carboxylic acids are C₁₋₂-alkyl-4EO-carboxylic acid, (C₁₆-C₁₈)-alkyl-2EO-carboxylic acid, (C₁₆-C₁₈)-alkyl-5EO-carboxylic acid, (C₁₆-C₁₈)-alkyl-10,5EO-carboxylic acid or (C₄-C₈)-alkyl-8EO-carboxylic acid. More preferably, the ethoxylated carboxylic acid is C₁₋₂-alkyl-4EO-carboxylic acid. Ethoxylated carboxylic acids are commercially available, for example, from Kao Chemicals GmbH (Emmerich, Germany) under the trade names Akypo RLM 25, Akypo RO 20, Akypo RO 50, Akypo RO 90, Akypo RCO 105 or Akypo LF2. In one preferred embodiment of the present invention, the ethoxylated carboxylic esters contain a (C₁₂-C₁₈)-alkyl-fragment and 3 to 6 EO-fragments. Examples are C₁₂-alkyl-4EO-carboxylic acid, or (C₁₂-C₁₈)-alkyl-5EO-carboxylic acid.

In one embodiment of the present invention, the emulsifier is at least one phosphate ester and at least one alkoxylated carboxylic acid. In another embodiment of the present invention, the emulsifier is at least the phosphate ester. In a further embodiment of the present invention, the emulsifier is at least one alkoxylated carboxylic acid.

Further emulsifiers (emulsifying agents) may comprise compounds, which may also be employed as (organic) solvents or surfactants. Preferred emulsifiers according to the present invention are alkoxylated fatty alcohols, alkoxylated esters, fatty alcohols or phosphate esters which are optionally alkoxylated.

Preferred fatty alcohols are cetyl alcohol or oleyl alcohol, in particular cetyl alcohol (1-hexadecanol). Alkoxylated fatty alcohols are preferably ethoxylated fatty alcohols. Ethoxylated fatty alcohols suitable as emulsifiers are commercially available from BASF AG (Ludwigshafen, Germany) under the trade names Lutensol XL-Series (such as XL 70), Emulan EL, Emulan NP 2080, Emulan OC, Emulan OG, Emulan OP25, or Emulan OU. Preferred examples of ethoxylated fatty alcohols are RO(C₂H₄O)_{X}H with R═C₁₀H₂₁ and x=4, 5, 6, 7, 8, 9, 10 and 14.

Alkoxylated esters are preferably ethoxylated esters. Ethoxylated esters are esters of carboxylic acids containing one or more ether groups (EO-fragments) within the ester fragment derived from the corresponding alcohol. Preferred ethoxylated esters are ethoxylated fatty acid esters, in particular ethoxylated esters of oleic acid, which is commercially available from BASF AG under the trade name Emulan A.

The presence of an emulsifier within the lubricant concentrate employed in the present invention is connected with the advantages of providing anti-corrosive properties, emulsifying effects, lowering the pH-value to the acidic range and also reducing the blackening during a dry lubrication process. It has to be indicated that the respective properties of the compounds indicated above as emulsifiers depend on the further compounds contained in the lubricant concentrate.

If present, the lubricant concentrate generally contains at least one emulsifier in an amount of at least 0.1 wt-%, preferably in an amount of 0.1 to 40 wt.-%, more preferred in an amount of 0.5 to 25 wt.-%.

Besides the above-indicated mandatory and optional components, the lubricant concentrate may contain one or more further components known by a skilled person such as surfactants, corrosion inhibitors, acids such as strong or weak organic acids, for example, saturated or unsaturated carboxylic acids containing one or more ether groups, chelating agents, solvents, biocidals or antioxidants. The optional components are chosen in a way that they are compatible with each other, for example, in respect of their miscibility.

Examples for suitable surfactants can be found in WO 01/107544 or U.S. Pat. No. 6,427,826. Preferred surfactants include alkylbenzenesulfonic acid, carboxylic acids, alkylphosphonic acids and their calcium, sodium and magnesium salts, polybutenylsuccinic acid derivatives, silicone surfactants, fluorosurfactants, and molecules containing polar groups attached to an oil-solubilizing aliphatic hydrocarbon chain. If stable and existing, the above indicated preferred surfactants are employed in their acidic form and not as salts. The surfactants are used in an amount to give desired results. This amount can range from 0 to about 30, preferably about 0.5 to about 20 wt.-% for the individual component, based on the total weight of the composition.

Examples of suitable chelating agents can be found under the respective definitions for step b) of the present invention.

In one embodiment of the present invention, the lubricant concentrate employed in step a) contains at least one fatty acid. The fatty acid may be any fatty acid known to the skilled person. Preferably, the fatty acid is a C₈-C₂₂-fatty acid such as capric acid, lauric acid, myistic acid, palmitic acid, stearic acid, oleic acid or linoleic acid. The fatty acid may be a saturated fatty acid, a mono-unsaturated fatty acid or a polyunsaturated fatty acid. Most preferably, the fatty acid is oleic acid. In one embodiment, the respective acid is completely or partially employed as a free fatty acid.

The term “free fatty acid” in connection with the present invention means that the acidic functional group (carboxylic group) of the respective fatty acid is not blocked by or reacts with any other component of the respective lubricant. Preferably, the respective lubricant does not contain any counter ions which may block and/or react with the carboxylic group of the respective fatty acid. In particular, the respective lubricant does substantially not contain any cationic ions or other cationic components which may act as a counter ion of the carboxylic group. In addition, the respective lubricant concentrate is preferably free of any amines.

If the lubricant concentrate contains any other components, which may block or react with the acidic functional group of the employed (free) fatty acid, the amount of fatty acid employed in the lubricant concentrate in this embodiment has to be raised to a level, which effects a concentration of preferably at least 0.1 wt.-% of (free) fatty acid. Methods for detection of the amount of the (free) fatty acids contained in a composition, such as a lubricant concentrate, are known in the art.

If present, the lubricant concentrate contains at least one fatty acid or a mixture of two or more fatty acids in an amount of at least 0.1 wt.-%, preferably in an amount of 0.1 to 25 wt.-% more preferably in an amount of 0.3 to 5 wt.-%

In those embodiments of the present invention where the lubricant concentrate employed in step a) further contains at least one fatty acid, the respective lubricant concentrates preferably have a pH-value in the acidic range. The pH-value is, for example, in the range of ≦4, preferably in the range of ≦3, more preferably of 1-3, in particular of (about) 2. If the respective lubricant concentrate is further diluted, for example, if a dry lubrication process is combined with a wet lubrication process, then the use solution (lubricant concentrate diluted with, for example, water) usually has a pH-value in the range of 5.5 to 7.5, preferably 7.

In another embodiment of the present invention, the lubricant concentrate employed in step a) further contains at least one acid. This acid does not fall under the definitions of a (free) fatty acid as indicated above. Preferably, this acid is selected from strong or weak organic acids, including alkoxylated carboxylic acids and salicylic acid.

More preferably, this acid is a weak organic acid such as propionic, glycolic, gluconic, citric, acetic or formic acid, in particular acetic acid. The presence of said (additional) acid within the lubricant concentrate effects a better adjustment of a lower pH-value of the -lubricant concentrate (in the-range-of ≦4), preferably a pH-value of 1-3, in particular of (about) 2. If present, the concentration of said (additional) acid is an amount of at least 0.1 wt.-%, preferably in an amount of 0.1 to 25%, more preferably 0.1 to 5.0 wt.-%.

In another embodiment of the present invention, a lubricant concentrate is employed containing 0.1 to 25 wt-% of at least one oil, 0.1 to 40 wt.-%, preferably 0.5 to 25 wt.-% of at least one emulsifier, 0 to 25 wt.-%, preferably 0 to 5.0 wt.-% of at least one fatty acid, 0 to 5.0 wt.-% of at least one acid and 5 to 95 wt.-% of water and/or at least one organic solvent. Preferred organic solvents are glycol ethers, in particular dipropylene glycolmethyl ether, which is commercially available under the trade name Dovanol DPM from Dow Chemicals. Optionally, mixtures of water and at least one organic solvent may also be employed. If the lubricant concentrate contains an organic solvent, preferably more than 10 wt.-%, said concentrate is preferably applied onto the conveyor belt as a (clear) solution and/or discontinuously.

In another embodiment of the present invention, a lubricant concentrate is employed containing 0.1 to 25 wt.-% of at least one oil, 0 to 95 wt.-% of water, 0.1 to 95 wt.-% of at least one emulsifier, 0 to 5 wt.-% of at least one acid, and 0 to 30 wt.-% of at least one further component, preferably a surfactant. Preferably, the lubricant concentrate is applied onto the conveyor belt as an emulsion and/or discontinuously.

In one embodiment of the present invention, a lubricant concentrate is employed which does not contain any neutralizer in a substantial amount. In this embodiment, the pH-value of the respective lubricant concentrate is preferably in the acidic range and/or they lubricant concentrate contains a fatty acid. In a substantial amount in connection with neutralizers as well as the below indicated complexing agents or polyalkylene polymers means that the neutralizer is not present at all within the employed lubricant concentrate or its concentration is below an amount of 0.05 wt. %, preferably 0.01 wt-% of the lubricant concentrate. Examples for neutralizers (neutralizing agents) are alkaline metal hydroxides such as potassium hydroxides and sodium hydroxides, ammonia, buffers such as sodium carbonate, potassium carbonate or sodium phosphate, alkyl amines, such as primary, secondary, tertiary amines or alkanol amines and amines such as fatty alkyl substituted amines.

In another embodiment of the present invention, a lubricant concentrate is employed which does not contain a polyalkylene glycol polymer in a substantial amount. Such polyalkylene glycol polymers include polymers of alkylene oxides or derivatives and mixtures or combinations thereof, usually having a molecular weight of at least 1000 up to about hundreds of thousands. Such polyalkylene glycol polymers are disclosed, for example, in U.S. Pat. No. 6,855,676.

The lubricant concentrate employed in step a) may be prepared as known in the art, for example, by mixing the individual components in any order. However, lubricant concentrates according to the present invention may also be prepared by diluting a first concentrate containing at least one oil with a solvent such as water. The obtained mixture preferably contains at least 0.1 wt.-% of at least one oil or of a mixture of two or more oils.

Step b):

The liquid composition employed in step b) is applied to the surface of the conveyor belt. The components contained within said liquid composition may be any component under the proviso that the pH-value of the liquid composition is in the range of ≧5 after the individual components of the respective liquid composition are mixed together.

The liquid composition contains as component a) at least one base. Preferably, the base is selected from an alkanol mine, an amine, ammonia, ammonia hydroxide, urea, an alkaline hydroxide, a buffer, a fatty amine, an alkoxylated fatty amine, a fatty amine oxide or an alkoxylated fatty amine oxide.

The alkonol amine is preferably an ethanol amine, more preferably monoethanol amine (MEA), diethanol amine (DEA) or triethanol amine (TEA). An alkaline hydroxide (alkaline metal hydroxide) is preferably potassium hydroxide or sodium hydroxide, more preferably potassium hydroxide. Ammonia (NH₃) and ammonia hydroxide (NH₄OH) are usually employed as an aqueous liquid. Besides urea, any stable derivative of urea known to a person skilled in the art may also be employed as a base.

The term amine comprises any amine different to the above-defined alkanol amines or the below indicated fatty amines, alkoxylated fatty amines or the respective amine oxides thereof. An amine may be, for example, a primary, secondary or tertiary alkyl amine, or a cyclic amine, such as morpholine. A buffer may be a known buffer such as sodium carbonate, potassium carbonate, sodium phosphate, sodium hydrogen phosphate, and sodium dihydrogen phosphate.

A fatty amine may be any fatty amine known by a person skilled in the art. An alkoxylated fatty amine is derived from the respective fatty amine, wherein the respective alkoxylated compound is preferably an ethoxylated compound containing one or more fragments derived from ethylene oxide (EO-fragment). The respective fatty amine or alkoxylated fatty amine may be a primary, secondary or tertiary amine. The (alkoxylated) fatty amine contains at least one substituent, which is a saturated or unsaturated, branched or linear alkyl group having between 8 to 22 carbon atoms (C₈-C₂₂). The (alkoxylated) fatty amine may also be a mixture of two or more (alkoxylated) fatty amines according to said definition.

Preferably, a fatty amine is a compound according to formula (III)

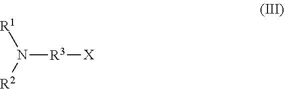

wherein R¹ is an alkyl group having between 8 to 30 carbon atoms, and R² is a hydrogen, alkyl group or hydroxyalkyl group having 1 to 4 carbon atoms, R³ is hydrogen or an alkylene group having from 2 to 12 carbon atoms, and X (if R³ is not H) is a hydrogen or a hydrophilic group such as —NH₂, OR⁴, —SO₃— (amine alkoxylate), amine alkoxylate or alkoxylate, and R⁴ is hydrogen or (C₁-C₁₈)-alkyl.

Preferred alkoxylated fatty amines are derived from the compounds according to formula (III), whereby the respective compounds additionally contain one or more alkoxylate-fragments, preferably one or more fragments derived from ethylene oxide (ethoxylate-fragment or EO-fragment), more preferably 1 to 40 and most preferably 5 to 25 fragments derived from ethylene oxide. The respective alkoxylate-fragments may be contained within any substituent R¹-R³, preferably within substituent R¹.

A fatty amine oxide or an alkoxylated fatty amine oxide may be any compound derived from the above-indicated fatty amines or alkoxylated fatty amines, respectively, which are tertiary amines additionally having an oxygen atom bound to the (tertiary) nitrogen atom.

Examples of fatty amines (X or R³═H) are: dimethyl decyl amine, dimethyl octyl amine, octyl amine, nonyl mine, decyl amine, ethyl octyl amine and mixture thereof.

When X is —NH₂, preferable examples are alkyl propylene amines such as N-coco-1,3-diaminopropane, N-oleyl-1,3-diaminopropane, N-tallow-1,3-diaminopropane or mixtures thereof.

Examples of preferable ethoxylated mines are ethoxylated tallow amine, ethoxylated coconut mine such as cocoamine ethoxylates with 1-30 EO-fragments, which are commercially available, for example, as Ethomeen C15 or Ethomeen C25 (Akzo Nobel), ethoxylated alkyl propylene amines and mixtures thereof.

Examples of fatty amine oxides are tallow bis-(2-hydroxyethyl)amine oxide, C₁₄-alkyl dimethyl) amine oxide, (C₁₂-C₁₄) alkyl (dimethyl) amine oxide and mixtures thereof.

More preferably, the base (component a) is at least one compound selected from an alkanol amine, ammonia hydroxide, alkali hydroxide, urea, sodium carbonate, potassium carbonate, a fatty mine according to formula (III), wherein X is —NH₂ or a fatty amine oxide according to genera! formula (III), wherein X is H and which is a tertiary amine additionally having an oxygen atom bound to the nitrogen atom.

Even more preferably, the base (component a) is at least one compound selected from an alkonol amine, ammonium hydroxide, potassium hydroxide, or sodium hydroxide. Most preferably, the base is monoethanole amine (MEA), diethanole amine DEA) or triethanole amine (TEA).

The liquid composition contains component a) in an amount of at least 2 wt.-%, preferably in an amount of 2 to 25 wt.-%, more preferably in an amount of 4 to 20 wt.-% and most preferably in an amount of 4 to 15 wt.-%.

The liquid composition (employed in step b) contains as component b) at least one fatty acid. The fatty acid may be any fatty acid known to the skilled person. Preferably, the fatty acid is a C₈-C₂₂-fatty acid such as capric acid, lauric acid, myristic acid, palmitic acid, stearic acid, oleic acid or linoleic acid. The fatty acid may be a saturated fatty acid, a mono-unsaturated fatty acid or a polyunsaturated fatty acid and mixtures thereof. Most preferably, the fatty acid is oleic acid.

Due to the pH-value of the liquid composition employed in step b) of the present invention, the fatty acid (component b) is usually completely or at least partially present in its unprotonated form within said liquid composition. However, the respective fatty acid may be employed in its free form when preparing the liquid composition. The base (component a) and the fatty acid (component b) usually undergo a chemical reaction and/or form an adduct with each other. The reaction product and/or adduct of the base and the fatty acid can be considered as a soap, which means that the fatty acid employed is completely or at least partially transferred into a corresponding salt.

The liquid composition contains component b) in an amount of at least 2 wt.-%, preferably in an amount of 2 to 30 wt.-%, more preferably in an amount of 5 to 25 wt.-% and most preferably in an amount of 8 to 20 wt.-%.

The liquid composition employed in step b) of the present invention has a pH-value in a range of ≧5 more preferably in the range of ≧7, in particular in the range of 9 to 13.

Within the liquid composition employed in step b) of the present invention, component a) (the base) and component b) (fatty acid) may be present at any ratio to each other under the proviso that the pH-value of the liquid composition is in the range of ≧5. Examples of molar ratios of the base versus the fatty acid are 0.63:1, 2.4:1, 4.0:1 or even 25.0:1. Preferably, the liquid composition contains a molar excess of the base versus the fatty acid. Most preferably, the molar ratio of the base versus the fatty acid is in the range of 2.0:1 to 4.5:1 [mol/mol].

In an embodiment of the present invention, the liquid composition employed in step b) additionally contains water. Preferably, water is employed as a balance, which means that water is added in an amount of 100 wt.-% minus the sum of the residual components of the respective liquid composition. If present, the concentration of water in the liquid composition is in an amount of 0.1 to 96 wt.-%, more preferably in an amount of 20 to 90 wt.-%, most preferably in an amount of 40 to 80 wt.-%.

Besides the base, the fatty acid and optionally water, the liquid composition employed in step b) may contain one or more further components such as surfactants, emulsifiers, solvents, hydrotropes, corrosion inhibitors, stress-cracking inhibiting agents, coupling agents, anti-wear agents, antimicrobial agents, friction or viscosity modifiers, anti-foaming agents or chelating agents. The optional components are chosen in a way, that they provide a pH-value of the liquid composition in the range of ≧5 when mixed together.

The liquid composition may contain a chelating agent in one embodiment. In particular, such chelating agents are ethylene diamine tetraacetic acid (EDTA) or salts thereof, in particular disodium or tetrasodium salt, iminodisuccinic acid sodium salt, trans-1,2-diaminocyclohexane tetracetic acid monohydrate, diethylene triamine pentacetic acid, sodium salt of nitrilotriacetic acid, pentasodium salt of N-hydroxyethylene diamine triacetic acid, trisodium salt of N,N-di(beta-hydroxyethyl)glycine, or sodium salt of sodium glucoheptonate.

In one embodiment, the liquid composition may further contain at least one hydrotrope. Hydrotropes are known to a person skilled in the art and disclosed, for example, in EP-B 1 444 316 or U.S. Pat. No. 4,604,220. Preferably, the hydrotrope is an anionic sulfonate such as the alkali metal salts of C₆-C₁₈ alkyl sulfonates such as 1-octane sulfonate, the alkali metal aryl sulfonates, C₆-C₃₀ akaryl sulfonates such as the sodium C₂-C₁₈ alkyl naphthalene sulfonates, sodium xylene sulfonates, sodium cumene sulfonates, alkyl benzene sulfonates or alkylated diphenyl oxide disulfonates. More preferably, the hydrotrope is the sodium salt of xylene sulfonic acid or the sodium salt of cumene sulfonic acid.

In another embodiment, the liquid composition may further contain at least one stress-cracking inhibiting agent (stress-cracking inhibitor). Preferably, the stress-cracking inhibiting agent is an alkyl phosphate ester or an alkyl aryl phosphate ester. Further suitable stress-cracking inhibiting agents are selected from polyoxyethylene decyl ether phosphoric acid or the potassium salt thereof, polyoxyethylene nonylphenyl ether phosphoric acid or the potassium salt thereof, polyoxyethylene dinonylphenyl ether phosphoric acid or the potassium salt thereof, and mixtures thereof.

In another embodiment, the liquid composition may further contain at least one emulsifier as defined under step a).

If present, the liquid composition contains the chelating agent, the hydrotrope, the emulsifier or the stress-cracking inhibiting agent each in an amount of ≦30 wt.-%, more preferably in an amount of 10-30 wt.-%, most preferably in an amount of 15-25 wt.-%. However, if the liquid composition contains at least three components selected from the chelating agent, the hydrotrope, the emulsifier and the stress-cracking inhibiting agent, the sum of the respective individual amounts of all components is preferably ≦40 wt.-%.

In one embodiment of the present invention, the liquid composition may further contain at least one oil as defined above for step a). Preferably, the same oil or mixtures of two or more oils are employed in step a) and in step b). If present, the liquid composition contains the oil in an amount of ≦10 wt.-%.

In one embodiment of the present invention, a liquid composition is employed containing 4 to 20 wt.-% of at least one base, 5 to 25 wt.-% of at least one fatty acid, 40 to 80 wt.-% of water and 0 to 30 wt.-% of at least one chelating agent, at least one hydrotrope, at least one emulsifier and/or at least one stress-cracking inhibitor. Preferably, the base is present in a molar excess versus the fatty acid.

The liquid composition employed in step b) may be prepared as known in the art, for example, by mixing the individual components in any order.

Operation Mode of Steps a) and/or b):

The method according to the present invention can be employed on any conventional conveyor belt systems (units) known to a person skilled in the art. The conveyor belt system, in particular the chains and tracks, may be partially or completely made of any material known in the art such as steel, in particular stainless steel, or plastic. Such conveyor belt (installations) are widely used for example in the food and/or beverage industry, for example, for the cleaning, filling or refilling of containers such as bottles. Usually, a conveyor belt system contains several individual conveyor belts (conveyor belt sections).

The object to be transported on the respective conveyor belt may be any object known by a skilled person to be employed in this respect, such as containers, in particular bottles, cans or cardboards. Said object may be partially or completely made of any material such as metal, glass, carton or plastic, preferably made of glass or plastic. Preferred plastic articles or containers are made of polyethylene terephthalate (PET), polyethylene naphthalate (PEN), polycarbonate (PC) or polyvinylchloride (PVC).

In one embodiment of the present invention the conveyor belt is partially or completely made of plastic, and/or the object transported on the conveyor belt is partially or completely made of plastic, in particular a plastic bottle. Preferably, the plastic object (article) is made of polyethylene terephthalate (PET), polyethylene naphthalate (PEN), polycarbonate (PC) or polyvinylchloride (PVC). This embodiment of the present invention is preferably employed in a process for filling and in particular for refilling such objects.

In the method according to the present invention, the lubricant concentrate employed as a dry lubricant in step a) may be applied onto the respective conveyor belt by any method known in the state of the art. WO 01/07544 provides an overview of potential ways of applying the lubricant concentrate onto the (upper) surface of the conveyor belt. As an applicator a spray nozzle, a metered diaphragm pump, a brush applicator or a so-called flicker may be employed. The lubricant concentrate may be applied continuously or preferably discontinuously. For example, the lubricant concentrate may be discontinuously applied onto the conveyor belts surface every five minutes, twenty minutes or even every 24 hours, depending on the objects to be transported.

The liquid composition employed in step b) of the present invention can be applied to the surface of the conveyer belt by any method known in the state of the art. Usually, the liquid composition is carried out in a way which corresponds to a wet lubrication (process). This means that the liquid composition as described above is preferably diluted to a “use solution (of the liquid composition)”. Usually, the use solution of the liquid composition is obtained by diluting the respective liquid composition with a solvent, preferably with water. The dilution factor is usually in the range of 50 to 500, preferably in the range of 80 to 150, most preferably (about) 100.

By consequence, the use solution contains the individual compounds of the liquid composition as described above in an amount, which equals the ordinary, preferred, more preferred or even most preferred amount of the respective component divided by the dilution factor. For example, a use solution with a dilution factor of 100 contains component a) in an amount of at least 0.02 wt.-%, preferably in an amount of 0.02 to 0.25 wt.-%, more preferably in an amount of 0.04 to 0.2 wt.-% and most preferably in an amount of 0.04 to 0.15 wt.-%.

In one embodiment of the present invention a use solution of the liquid composition is employed in step b) containing i) at least 0.02 wt.-%, more preferably 0.04 to 0.2 wt.-% of at least one base, ii) at least 0.02 wt.-%, more preferably 0.05 to 0.25 wt.-% of at least one fatty acid, iii) 0 to 0.3 wt.-%, more preferably 0 to 0.25 wt.-% of at least one chelating agent, at least one hydrotrope, at least one emulsifier and/or at least one stress-cracking inhibitor and iv) at least 50 wt.-%, more preferably at least 95 wt.-% of at least one solvent, preferably water. Preferably, the base is present in a molar excess versus the fatty acid.

This means further that the liquid composition is applied to the surface of the conveyer belt in a way, that a significant amount of the liquid composition flows off from the surface of the respective conveyer belt. Preferably, at least 30% of volume of the applied amount of liquid flows off, more preferably at least 50% by volume, in particular at least 90% by volume. Preferably, the liquid composition is added at a ratio of 1.5 to 20 l/hour on the respective conveyor belt (per conveyor belt track depending on ordinary size).

For example, (the use solution of) the liquid composition of step b) may be applied via an automatic dosing system. The typical use concentration is 0.6-1.2% w/w, (1 part liquid composition to 83-167 parts water), depending on the application, water hardness and degree of soiling. Preferably, this is recommended for use where the water hardness is less than 185 mg/l calcium carbonate (maximum tolerance for 1.2% w/w given), the use of softened water advised.

Step b) is carried out to effect a cleaning of the conveyor belt to remove dirt from the conveyor belt's surface due to the operator conditions according to step a). In addition, step b) according to the present invention also provides a lubrication effect. Therefore, step b) is carried out for cleaning and (optionally) lubricating the conveyor belt.

The liquid composition can be applied to the conveyor belt's surface, for example, by a spray nozzle or any other pump known to a skilled person. There is no limit for the operation time of carrying out step b). Preferably, the operation time of step a) exceeds that of step b), more preferably by a factor of at least 10, much more preferably by a factor of at least 20, and in particular by a factor of at least 40.

In one embodiment of the present invention, the method is carried out continuously, whereby steps a) and b) are carried out in alternate order. Without any problems, it is possible to switch between steps a) and b) several times, whereby the intervals of operation for steps a) and b) may vary. It is also possible to carry out step b) only in some sections of the conveyor belt system.

Said embodiments are preferably employed in transportation of objects on conveyor belts, whereby the conveyor belt is integrated into different operation units (sections) to carry out for example bottle washing, sorting, filling, labelling or packaging steps. Preferably, said embodiments are employed in the process of filling or refilling of glass or plastic containers, in particular glass or plastic bottles, in particular on a conveyor belt partially or completely made of steel, preferably stainless steel, or plastic.

Preferably, the individual sections of the conveyor belt may be integrated into, connected with or placed in between a depelletizer, a bottle sorting unit, a bottle washer, a filler unit, a capping unit, a labelling unit, a packaging unit (area), a crate conveyor unit and/or an area for electronic bottle inspections. The respective sections (units) may be connected with each other in any order and/or number.

The following examples serve to present a more detailed explanation of the invention.

### EXAMPLES

In the following, all percent (%)-volumes of components of compositions are expressed as percent-by-weight (wt.-%) unless indicated otherwise.

### Example I

### Dry Lubrication According to Step a)

1. Track Conveyor Testing

1.1 Description of Test Method Lubricity and Durability

1.1.1 Test Track

The trials are carried out on a pilot conveyor facility. This pilot conveyor contains stainless steel and plastic (Acetal) test tracks.

1.1.2 Test Procedure

The following standard test procedure is applied:
1. Prior doing any trials, ensure that the test track is free of residues. If necessary, clean the track with an acidic or alkaline cleaner and/or with alcohol to remove any traces of lubricants from the previous trial.
2. Rinse the track with water (approx. 10 min) and dry it with Kleenex.
3. Start the program for the digital track conveyor system.
4. After 2 min: pipette 10 ml of the respective composition directly on the chain. This process has to be done very carefully and slowly to ensure, that the whole chain surface is being treated. Use a plastic cloth or a brush to support spreading.
5. After 20 min from start: switch on the tap water flush (approx. 8 ltr./min.).
6. After 10 min rinsing: stop program
1.2 Evaluation

During the trial, 6-8 bottles are placed on the test track. The pulling power (Fz) is constantly measured via an electronic scales with A/D converter. The measurement is limited to a maximum of 2 kg. The coefficient pulling power/weight of bottles or cans represents the friction coefficient which expresses the lubricity (μ=F_{Z}F_{N}). This data is finally transferred to MS Excel and the values (μ) can be read out in the middle of the amplitude. Durability is recorded during the water flush. Durability is the resistance of a lubricant to unfavourable conditions such as heavy loading or water wash off.

### 2. Trials

2.1. Glass Bottles on Stainless Steel Tracks

Tests are carried out with 8 glass bottles with a total weight of 8.1 kg.
2.1.1. Concentrate Compositions According to the State of the Art

A concentrate of a lubricant 1 is prepared, containing 3.68% N-oleyl-1,3-diaminopropane, 3.6% (C₁₆₋₁₈) alkyl (9EO) carboxylic acid and 6% polyethylene glycol (M=200) added up with softened water to 100%. 5% of this lubricant 1 diluted with 95% H₂O is used as concentrate A and 95% of this lubricant 1 diluted with 5% H₂O is used as concentrate B.

2.1.2. Concentrate Compositions According to the Present Invention

Oil in water emulsions are prepared (listed below) by shaking the ingredients in small 20 ml screw top glasses.

Concentrate C: 50% silicone oil (Dow Corning 200) and 50% H₂O
Concentrate D: 95% sunflower oil and 5% H₂O
Concentrate E: 75% mineral oil and 25% H₂O

2.1.3. Results

Table 1 below shows friction coefficients (μ) at different time stages. As the application of lubricant starts after 2 min. the values at 10 and 20 min. show lubricity. The water flush starts after 20 min, so 25 min and 30 min are indicators for the durability. Values (μ)>0.15 show insufficient lubricity and exceeds the measurement device limit.

TABLE 1

| Concentrate | 0 min. | 10 min. | 20 min. | 25 min. | 30 min. |
|---|---|---|---|---|---|
| A | 0.2 | 0.20 | 0.20 | >0.25 | >0.25 |
| B | 0.23 | 0.125 | 0.10 | >0.25 | >0.25 |
| C | 0.22 | 0.135 | 0.14 | 0.14 | 0.185 |
| D | 0.20 | 0.10 | 0.10 | 0.11 | 0.2 |
| E | 0.20 | 0.09 | 0.09 | 0.11 | 0.2 |

The concentrates of the invention (C to E) show in most cases a significant decrease of friction compared to prior art (A-B), when employed in an dry lubrication process according to step a) of the present invention. In addition, an improved performance is noticed with concentrates C to E because of longer remaining lubricity during the wash off (rinse step starting after 20 min).

### Example II

### Combination of Dry Lubrication and the Cleaning According to Steps a) and b)

The following standard test procedure is applied:
1. Prior doing any trials, ensure that the test track is free of residues. If necessary, clean the track with an acidic cleaner and/or with alcohol to remove any traces of lubricants from the previous trial.
2. Rinse the track with water (approx. 10 min.) and dry it with Kleenex.
3. Start the program for the digital track conveyor system.
4. After 2 min.: pipette 10 ml of the concentrate 1 directly on the chain. This process has to be done very carefully and slowly to ensure that the whole chain surface is being treated. Use a plastic cloth or brush to support spreading.
5. After 10 min. from start: switch on permanent dosing of the use solution of the liquid composition of step b).
6. After 31 min. from start: stop program.

TABLE 2

| Step a) | | Step b) frictions coefficients at | | | |
|---|---|---|---|---|---|
| Lubricant | time | | | | |
| concentrate | 8 min. | 11 min. | 15 min. | 20 min. | 30 min. |
| 100 wt.-% | 0.06 | 0.07 | 0.07 | 0.08 | 0.12 |
| sunflower oil | | | | | |
| 100 wt.-% | 0.10 | 0.10 | 0.10 | 0.12 | 0.12 |
| white oil | | | | | |

Table 2 shows friction coefficients (μ) at different stages. Step a) is carried out for 10 minutes employing the lubricant concentrates indicated in table 2. Unless indicated otherwise, the experiments are carried out in accordance with example 1, items 1 and 2. After 10 minutes, the conditions are switched to cleaning conditions according to step b) of the present invention. In step b) a use solution is employed, which use solution is obtained from a liquid composition by dilution with water at a factor of 100. The liquid composition contains 10 wt.-% triethanol amine and 8 wt.-% oleic acid, the balance (total of 100 wt.-%) is obtained by addition of water. The respective use solution is continuously sprayed on the conveyor belt at a rate of 5 l/h. The white oil employed is commercially available from Chevron Nederland under the trade name “Technical White Oil 40 C”.

The experiments of table 2 demonstrate that a stable lubricity is obtained by employing in step b) a liquid composition containing a base and a fatty acid. Furthermore, the experiments of table 1 and 2 indicate that a better lubricity (lower μ-coefficients) is obtained in step a) under dry lubrication conditions compared to the cleaning conditions of step b).

1. A method of lubricating a conveyor belt comprising the steps as follows:
a) a lubricant concentrate containing at least one oil is employed in a dry lubrication process,
b) afterwards, a liquid composition is applied to the surface of the conveyor belt, wherein
the pH-value of the liquid composition is in a range of ≧5,
the liquid composition contains as component a) at least one base and
the liquid composition contains as component b) at least one fatty acid.

2. A method according to claim 1, wherein in the lubricant concentrate the oil is at least one vegetable oil and/or synthetic oil.

3. A method according to claim 1, wherein the conveyor belt is partially or completely made of steel or plastic and/or the object transported on the conveyor belt is partially or completely made of glass or plastic.

4. A method according to claim 1, wherein the lubricant concentrate contains
0.1 to 25 wt.-% of at least one oil,
0.1 to 50 wt.-% of at least one emulsifier,
0 to 25 wt.-% of at least one fatty acid, and
5 to 95 wt.-% of water and/or at least one organic solvent.

5. A method according to claim 1, wherein the lubricant concentrate is applied onto the conveyor belt as an emulsion.

6. A method according to claim 1, wherein the lubricant concentrate contains at least 95 wt.-% of at least one oil.

7. A method according to claim 4, wherein the emulsifier is at least one phosphate ester having the formula (I) or (II) 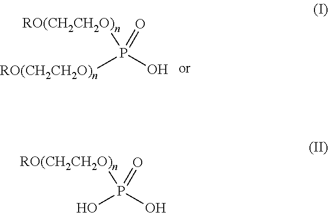
where R is an alkyl or alkylaryl group; n can (independently from another) equal from 1 to 10;
and/or at least one ethoxylated carboxylic acid containing a (C₄-C₁₈)-alkyl-fragment and 1 to 6 EO-fragments.

8. A method according to claim 1, wherein in the liquid composition (in step b) the base is selected from an alkanol amine, an amine, ammonia, ammonia hydroxide, urea, an alkaline hydroxide, a buffer, a fatty amine, an alkoxykited fatty amine, a fatty amine oxide or an alkoxylated fatty amine oxide.

9. A method according to claim 1, wherein the liquid composition (in step b) contains a molar excess of the base versus the fatty acid.

10. A method according to claim 9, wherein in the liquid composition (in step b) the base is monoethanolamine (MEA), diethanolamine (DEA) or triethanolamine (TEA) and/or the fatty acid is oleic acid.

11. A method according to claim 1, wherein step b) is carried out for cleaning and optionally lubricating the conveyor belt.

12. A method according to claim 1, which method is carried out continuously with steps a) and b) in alternate order.

13. A method according to claim 1, wherein the operation time of step a) exceeds that of step b) by a factor of at least 20.

14. A method according to claim 1, wherein the pH-value of the liquid composition employed in step b) is in the range of 9 to 13.

15. A method according to claim 1, wherein the liquid composition is employed as a use solution in step b).
